(19) United States
(12) Patent Application Publication
(10) Pub. No.: US 2025/0300332 A1
(43) Pub. Date: Sep. 25, 2025

(54) Internal Built-in Tab Fuses for Secondary Battery Cells, and Secondary Battery Cells Containing Such Internal Fuses

(71) Applicant: SES Holdings Pte. Ltd., Singapore (SG)

(72) Inventors: Hong Gan, Woburn, MA (US); Zhuhua Cai, Woburn, MA (US); Seung Wan Kim, Woburn, MA (US); Qichao Hu, Arlington, MA (US); Robert Galyen, Noblesville, IN (US)

(21) Appl. No.: 18/643,475

(22) Filed: Apr. 23, 2024

Related U.S. Application Data
(63) Continuation-in-part of application No. 18/613,275, filed on Mar. 22, 2024, now abandoned.

(51) Int. Cl. H01M 50/583; H01M 50/595

(52) U.S. Cl. CPC H01M 50/583; H01M 50/595; H01M 2200/103; H01M 2200/106

(57) ABSTRACT

Fuses, for example, for preventing thermal runaway, that are built-in electrode tabs of current collectors of secondary battery cells and that are located internal to the secondary battery cells. In some embodiments, a built-in tab fuse of this disclosure includes an integral tab portion that is integral and monolithic with the current collector and a free-standing tab component that is spaced from the integral tab portion by a gap. The fuse spans the gap. In some embodiments, the fuse includes a material different from the material that composes the current collector. In some embodiments, a built-in tab fuse of this disclosure is covered by a thermally insulating material.

### RELATED APPLICATION DATA

This application is a continuation-in-part of U.S. Non-Provisional patent application Ser. No. 18/613,275, filed Mar. 22, 2024, and titled “Internal Built-in Tab Fuses for Secondary Battery Cells, and Secondary Battery Cells Containing Such Internal Fuses”, which is incorporated by reference herein in its entirety.

### FIELD

The present disclosure generally relates to the field of secondary battery safety. In particular, the present disclosure is directed to internal built-in tab fuses for secondary battery cells, and secondary battery cells containing such internal fuses.

### BACKGROUND

Lithium (Li)-metal batteries have high energy density (>300 Wh/kg) and are considered to be the next generation battery technology for many applications, including electrical vehicles, such as electric cars, trucks, and the like, as well as electric aircraft, among others. Due to the potential for lithium dendrite formation during cycling, Li-metal cells could develop an internal short circuit randomly within the cell, leading to uncontrolled reactions, generating heat, and then triggering thermal runaway. A solution is needed to mitigate or reduce the risks of cell explosions by limiting the total magnitude of heat generation and the rate of heat generation (per unit time) to enable the heat dissipation to effectively compete with heat generation, which will reduce the severity of the thermal runaway incidents.

### SUMMARY

In one implementation, the present disclosure is directed to a secondary-battery cell, which includes a container; an internal core, located within the container, that includes a plurality of current collectors and plurality of fused tabs corresponding, respectively, to the plurality of current collectors, wherein each fused tab includes an integral tab portion that is directly connected to a corresponding one of the current collectors and is composed of a first electrically conductive material; a freestanding tab component spaced from the integral tab portion so as to define a gap between the freestanding tab component and the integral tab portion, the freestanding tab component composed of a second electrically conductive material; and a built-in tab fuse that comprises a third electrically conductive material that is different from each of the first and second electrically conductive materials and that spans the gap so as to electrically connect the integral tab portion and the freestanding tab component with one another and to define a melt region between the integral tab portion and the freestanding tab component.

In another implementation, the present disclosure is directed to a secondary-battery cell, which includes a container; an internal core, located within the container, that includes a plurality of current collectors and plurality of fused tabs corresponding, respectively, to the plurality of current collectors, wherein each fused tab is designed and configured to not melt under operating electrical currents and includes a built-in tab fuse designed and configured to melt at a predetermined excursion electrical current greater than each of the operating electrical currents; and a dielectric tape applied to the built-in tab fuse.

In yet another implementation, the present disclosure is directed to a method of manufacturing a secondary-battery cell having an internal core, contained in a container, that includes a plurality of current collectors each having a tab located within the container. The method includes, for each of the fused tabs: providing an integral tab portion that is integral to a corresponding one of the current collectors; providing a freestanding tab component so that it is spaced from the integral tab portion by a gap; and forming a built-in tab fuse that extends across the gap and electrically connects together the integral tab portion and the freestanding tab component.

In still another implementation, the present disclosure is directed to a method of designing an internal fused tab for a secondary battery, wherein the fused tab includes a built-in tab fuse and the internal fused tab has an integral tab portion and a freestanding tab component. The method includes determining a maximum design electrical current; determining electrical characteristics of an electrically conductive tape; and based on the maximum design electrical current: selecting a gap width between the integral and freestanding tab components so as to define a melt region for the electrically conductive tape; and selecting an amount of the electrically conductive tape to provide in the melt region so that, when the electrically conductive tape is provided to span the gap width, the electrically conductive tape melts when an electrical current flowing in the fused tab exceeds the maximum design electrical current.

### BRIEF DESCRIPTION OF THE DRAWINGS

For the purpose of illustration, the accompanying drawings show aspects of one or more embodiments of the disclosure. However, it should be understood that the scope of this disclosure is/are not limited to the precise arrangements and instrumentalities shown in the drawings, wherein:

FIG. 1 is a diagram illustrating an example secondary battery cell of the present disclosure having internal fused current-collector tabs on corresponding cathode electrodes, showing the cell prior to an internal short circuit (a), the cell during the internal short circuit but prior to blowing a fuse (b), and the cell after the fuse has blown (c);

FIG. 2 contains graphs of, from top to bottom, current versus time, cell voltage versus time, and temperature versus time for an example short-circuit testing of a 4.2 Ah Li-metal secondary battery cell;

FIG. 3 is a diagram illustrating four cathodes, one having a conventional cathode tab (a), one having a first built-in tab fuse (b), one having a second built-in tab fuse (c), and one having a third built-in tab fuse (d, d-1, d-2), with (d-1) and (d-2) illustrating the fuse covered by tape that provides tab reinforcement and heat insulation;

FIG. 4 is a diagram illustrating a method of making an example electrode using electrically conductive tape to make a fused current-collector tab, wherein (a-1) and (a-2) are, respectively, side and front views of the electrode, (b) is a front view of the electrode with a gap in the fused current-collector tab, and (c-1) and (c-2) are, respectively, front and side views of the cathode with the fused current-collector tab completed, with the electrically conductive tape spanning the gap;

FIG. 5A is an enlarged partial cross-sectional view of the fused current-collector tab of (c-1) and (c-2) of FIG. 4, showing example details of the fuse;

FIG. 5B is an enlarged partial elevational view of the fused current-collector tab of (c-1) and (c-2) of FIG. 4, showing example details of the fuse;

FIG. 6 is a diagram illustrating an example secondary-battery cell that includes a fused current-collector tab having a fuse comprising a metal film applied to a dielectric component; and

FIG. 7 is a diagram illustrating an example secondary-battery cell that includes a fused current-collector tab having a fuse comprising a semiconductor.

### DETAILED DESCRIPTION

The entire contents of the appended claims are incorporated into this Detailed Description section by reference and should be treated as if originally presented herein.

### General

In some aspects, this disclosure is directed to secondary battery cells having current-limiting built-in tab fuses located inside them. A conventional pouch cell has a multi-layer core structure comprising a stack of repeating anode/separator/cathode/separator substacks. Traditionally, an external fuse is used to limit electrical current during an external short circuit to protect the cell. In such conventional designs, the fuse can be placed on either the cathode-tab side or the anode-tab side or a fuse can be placed on each of those two sides. When an external short circuit occurs, the cell will quickly discharge with very high electrical current (proportional to the cathode/anode interface area) over a low external resistance. The current (electron-flow) will flow from anode to cathode through the tabs and fuse externally. A large amount of heat generated from the high current will activate the fuse to break the circuit, which will effectively shut down the current flow, stop the cell electrochemical reactions, and thus prevent further heat generation. By using the fuse to break the circuit and limit the heat generation, the cell will not enter into thermal runaway.

One example of this external fuse concept is the use of a cathode aluminum tab as a fuse by itself. When a Li-metal battery (LMB) was externally short circuited, the high current passing through the aluminum cathode tab generates enough heat (Q=I²Rt) to melt the aluminum tab (aluminum: m.p. of 660.32° C.) and thus break the electrical circuit. By controlling the aluminum tab cross-sectional area and its length, the resistance (R) can be adjusted for the heat generation (Q) to melt the tab. Once the tab melts, no fire or explosion would occur. The foregoing fuse concept is effective only for the external short circuit condition. When the cell develops an internal short circuit, such as a short circuit induced by Li dendrites growing through a separator, the external fuse will not be able to cut off the current flow inside the cell, and thus, cannot prevent the cell from entering thermal runaway.

This disclosure introduces secondary-battery cells each having internal built-in tab fuses added to individual current-collector tabs inside the cell's sealed container to limit the current flow to/from each electrode individually. Regardless of the location of internal shorts, the maximum current passing through each individual current-collector tab will be limited by the relevant connected internal built-in tab fuse(s).

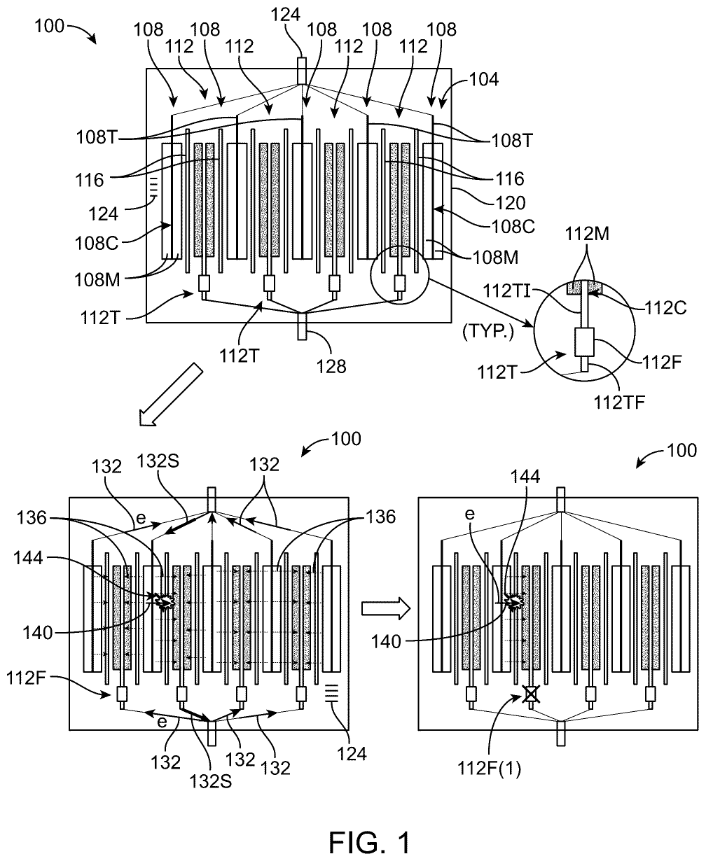

FIG. 1(a) illustrates the general approach in the context of a pouch-type secondary-battery cell 100, or simply “cell”, having a stacked core 104 composed of 5 anodes 108 and 4 cathodes 112 separated by separators 116 (only a few labeled to avoid cluttering the figure) contained within a container 120. In this example, the cell 100 utilizes a nonflammable liquid electrolyte 124 generally throughout the container 120, though it may be of a different type, such as a gel electrolyte or a solid electrolyte, or any combination or subcombination of differing electrolyte types. Each anode 108 includes a current collector 108C (only a couple labeled to avoid cluttering the figure) and anode-active material 108M (only a few locations to avoid cluttering the figure) in operative communication with the current collector, and each current collector has a tab 108T (only a couple labeled to avoid cluttering the figure) for electrically connecting that current collector to an anode output terminal 124. The anode-active material 108M can be any suitable anode active material, such as, for example, lithium metal, graphite or carbon, silicon, tin, tin oxide, etc. However, fundamentally, there are no limitations on the type of the anode-active material 108M. In this example, the tab 108T is integrally formed with and made of the same material as the current collector 108C, which in this example is copper, though another material can be used.

Similarly, each cathode 112 includes a current collector 112C (detail inset) and cathode-active material 112M (detail inset) in operative communication with the current collector, and each current collector has a fused tab 112T (detail inset) for electrically connecting that current collector to a cathode output terminal 128. The cathode-active material 112M (detail inset) can be any suitable cathode active material, such as, for example, a plating-stripping-type material, such as, for example, a metal-oxide-based material, such as a lithium cobalt oxide (LCO), a nickel cobalt aluminum oxide (NCA), a nickel manganese cobalt oxide (NMC), lithium iron phosphate (LFP), lithium iron manganese phosphate (LFMP), etc. Fundamentally, there are no limitations on the type of the cathode-active material 112M.

In this example, each fused tab 112T has: an integral tab portion 112TI (detail inset) that is integrally formed with and made of the same material as the current collector 112C; a freestanding tab component 112TF (detail inset) that is spaced from the integral tab portion, and a tab fuse 112F (detail inset) that extends from the integral tab portion to the freestanding tab component. In this example, the integral tab portion 112TI and the current collector 112C are aluminum, though another material could be used. Also in this example, the freestanding tab component 112TF is aluminum, though it may be another material in other embodiments. Various embodiments of the tab fuses 112F are described below.

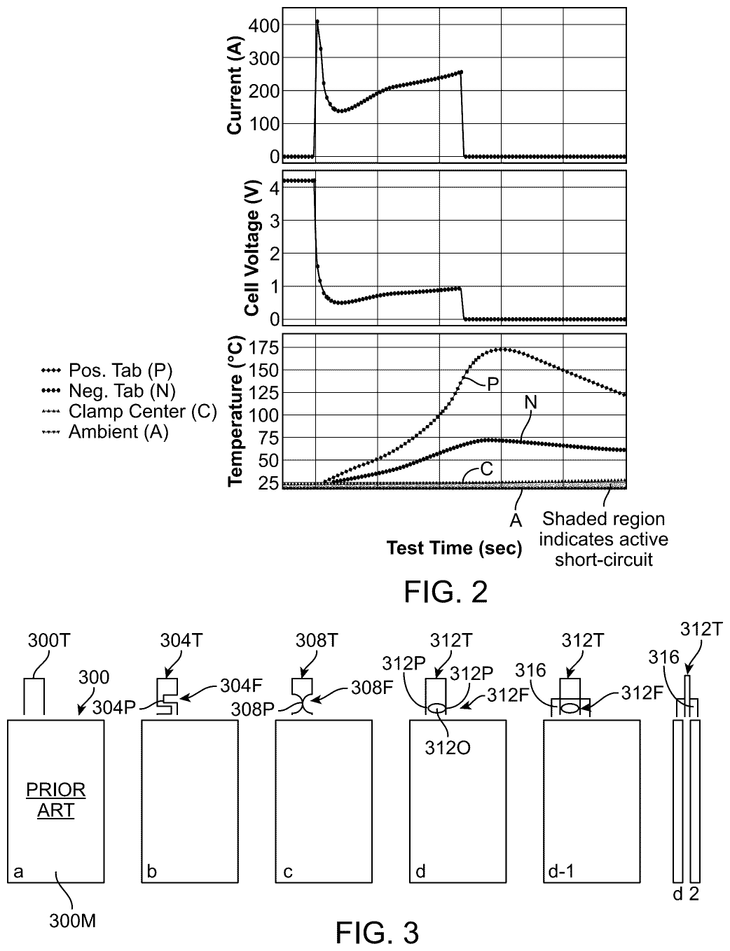

Results of an example external short circuit test is illustrated in FIG. 2. During external short circuit test of a 4.2 Ah cell, the cathode tab broke in 5s with an average of 200 Amp (5 mΩ external resistance). In this case, the aluminum tab exposed outside of the cell pouch was ˜7 mm in width, 0.2 mm in thickness, and 15 mm in length. Based on the aluminum density of 2.7 g/cc, the total weight of the above cathode tab was ˜0.0567 g. The relationship between the heat generation (Q) and the resistance (R)/current (I) and time (t) is shown here: Q=I²Rt. The electrical resistivity of aluminum is 2.82×10⁸ Ωm, which leads to the above-mentioned cathode tab resistance of 3.02×10⁴Ω. Under these conditions, the heat Q can be estimated to be ˜60.4 J or ˜1065.3 J/g for the aluminum. The heat capacity of aluminum is 0.897 J/g K, and that leads to −1187.6° C. temperature rise under adiabatic conditions. This estimated temperature rise could melt the aluminum tab (only need to raise temperature by 635° C. from 25° C. to aluminum melting point 660.32° C.) even with some heat dissipation under practical (e.g., non-adiabatic) testing conditions.

Heat dissipation cannot be predicted accurately due to its dependency on various factors, including environmental conditions, temperature, air flow, cell design, internal structures and materials. Experiments must be performed to determine if the heat generated during an external short circuit is sufficient to melt the aluminum tab. Although there are some uncertainties in determining these parameters accurately, the underlying principle remains applicable to all cell designs to lower the risk of thermal runaway under external short circuit conditions. Alternatively, an actual fuse can be used externally to fulfill the same function.

The above principle can also be applied to the individual internal built-in tab fuses of the present disclosure, such as the fuses 112F shown in FIG. 1(a). When a cell suffers an internal short circuit, such as a lithium-dendrite-induced internal short, it could happen at essentially any location inside the cell. Relative to the cell 100 of FIG. 1(a), during an internal short-circuit event, the electron and Li-ion flow directions are as shown in FIG. 1B, with arrows 132 and 132S indicating electron flow and arrows 136 (only a few labeled to avoid cluttering the figure) indicating Li-ion flow through the electrolyte 124. The arrows 132 indicate the non-short-circuit electron flow, while the arrows 132S indicate the short-circuit electron flow. Due to the high current, illustrated by arrow 140, passing through it, the short-circuit spot 144 will heat up. The higher the current 140 that flows through the short-circuit spot 144, the higher the temperature rises at this localized spot. If the heat generation becomes faster than the heat dissipation, then a thermal runaway reaction will be initiated, leading to fire or explosion of the cell 100. Thus, a key to avoiding thermal runaway is to limit the magnitude of the current flow 140 through the short circuit spot 144 to keep the heat generation slower than the heat dissipation.

This current control can be achieved by using the internal built-in tab fuse 112F on each individual fused cathode tab 112T as shown in FIG. 1(b) (a similar internal built-in tab fuse can also or alternatively be added on each anode tab). As shown in FIG. 1(b), the total current flow 140 passing through the short circuit spot 144 is equal to the discharge current from all the cathode/anode interfaces involving the Li-ion flow 136. The magnitude of current flow 140 through the short-circuited cathode-anode tab-pair will be much higher than the other cathode-anode tab-pairs as indicated by the boldness of the arrows representing the current flow 132S. Therefore, it is possible to distinguish the short circuit cathode-anode tab-pair 148 from the other cathode-anode tab-pairs (not labeled) by the magnitude of the current flow 132S. As mentioned in the external fuse example above wherein the fuse is located outside of the container, in some embodiments the aluminum fused tab 112T itself used for each individual cathode 112 can also function as a built-in tab fuse to limit the current flow by controlling its cross-section area and length. Based on the Q=I²Rt relationship, the cathode tab can be designed to have a preset resistance (R), which enables the tab to melt within a certain time (t) at the short-circuit current magnitude higher than the threshold level. By melting the aluminum fused tab 112R, the discharge-current flow from other cathode-anode pairs is cut off, and the short circuit current flow 140 will be limited only to the localized short-circuited cathode-anode pair 148 by activation (e.g., melting) of the corresponding tab fuse 112F(1) (FIG. 1(c)), thus limiting the heat generation.

Lithium-metal batteries (LMBs) and Li-ion batteries (LIBs) can develop an internal short circuit if a lithium dendrite grows through a separator or any other contamination particles break through a separator. The internal short circuit could range from soft short to hard short and is typically unpredictable. These internal short circuits could have uncontrollable heat generation depending on the severity of the short circuit. A soft short could generate a smaller amount of heat per unit time, and thus present a lower safety risk due to the faster heat dissipation than the heat generation. When the short circuit becomes more severe, more heat will be generated and reach a point where the heat generation is faster than the heat dissipation, leading to thermal runaway. Under the worst condition, a hard short will induce rapid heat generation and cause the cell to explode. Since it is an internal short, the battery management system (BMS) cannot be used to stop the process and thus cannot prevent thermal runaway. An objective of this disclosure is to introduce cell designs having an individual tab fuse built into electrode tabs that are internal to the cells to limit the short circuit current to the level that the heat generation rate is slower than the heat dissipation rate to reduce the risks of cell thermal runaway.

The general principles disclosed in FIGS. 1(a)-1(c) will limit the heat generation by cutting off the current flow via activation of the built-in tab fuses, specifically the tab fuses 112F in the example of FIGS. 1(a)-1(c). Such a built-in tab fuse design can, in principle, define the maximum current flow. The maximum current can be the maximum current density (mA/cm²) of a single cathode-anode interface multiplied by the total surface area of the cathodes of the entire cell. During the normal operation, the magnitude of current flow through each built-in tab fuse is not high enough (i.e., <the maximum current that the tab fuse can carry without melting) to activate the built-in tab fuse; thus the presence of the built-in tab fuse will not impact the cell's operation. However, when an internal short circuit occurs, the current flow through the short-circuit electrode-pair tabs (e.g., FIG. 1(b), bold arrow 132S) will exceed the maximum allowable current for the tab fuse, since the current was generated through multiple cathode/anode layers with larger total surface area of the cathodes. Under such conditions, the relevant one(s) of the tab fuse(s) will be activated (e.g., the fuse material(s) melt) and cut off the excess current flow from the rest of the cell (see, e.g., FIG. 1(c)). This concept will mitigate the thermal runaway by limiting the rate of heat generation.

### EXAMPLE EMBODIMENTS

There are many ways of implementing an internal built-in tab fuse of the present disclosure. Examples of tab configurations for the built-in tab fuse are shown in FIG. 3. FIG. 3(a) shows an electrode 300 having a conventional integral tab 300T that is integral with a current collector (not seen; located behind the electrode-active material 300M). As illustrated by the integral tab 300T, a conventional integral tab is typically rectangular in shape. To illustrate building fuses into tabs, FIG. 3 shows several examples of built-in tab fuses 304F, 308F, and 312F, each of which is part of, respectively, a corresponding fused tab 304T, 308T, and 312T that is integral with a corresponding electrode (not seen) and is made of a suitable electrically conductive material, such as a metal (e.g., aluminum, copper, etc.). In FIG. 3(b) the built-in tab fuse 304F is configured to provide a long and narrow conductive path 304P, in FIG. 3(c) the built-in tab fuse 308F is configured to provide a narrow conductive path 308P, and in FIG. 3(d) the built-in tab fuse 312F has an opening 3120 so as to define two narrow conductive paths 312P on either side of the opening. A primary concept in some embodiments is to modify electrical properties of a tab in a region to increase the resistance and thereby constrain the maximum current that can pass through that region during an internal short circuit, thus effectively creating a built-in tab fuse. The built-in tab fuse will melt at a short-circuit current exceeding a predetermined threshold, thereby breaking the circuit (see, e.g., FIG. 1(c) and the breaking of the fuse 112F(1)). At the same time, the resistance at the modified region (i.e., the built-in tab fuse) will not significantly impact the cell's power performance at normal operating conditions.

There are many tab designs that can achieve this goal and the provided examples in this section simply demonstrate the concept. In some embodiments in which the electrical modification of a tab involves reducing the cross-sectional area of the tab, such reduction in cross-sectional area could potentially weaken the tab's mechanical strength and may impact the manufacturability depending on the specific cell design. Therefore, in some embodiments it may be desirable/necessary to reinforce the mechanical strength of the built-in tab fuse by placing a dielectric tape (can also be heat insulating) on one or both broad faces of the tab for manufacturability. This is illustrated in FIG. 3, at FIG. 3(d-1) and FIG. 3(d-2), wherein dielectric tape 316 is wrapped around the portion of the fused tab 312T (FIG. 3(d)) containing the opening 3120 and the corresponding narrow conductive paths 312P formed by the presence of the opening. Although not shown, the built-in tab fuses 304F and 308F of, respectively, FIGS. 3(b) and 3(c) can be similarly strengthened, electrically insulated, and/or thermally insulated by adding a dielectric tape applied to the corresponding fused tab 304T and 308T. Examples of dielectric tape suitable for use as the dielectric tape 316 include, but are not limited to MYLAR® tape, polyimide tape, acetate cloth tape, silicone tape, and PTFE (e.g., TEFLON®) tape, among others. A factor in choosing a tape is the compatibility of the tape material with the chemistry of the cell at issue.

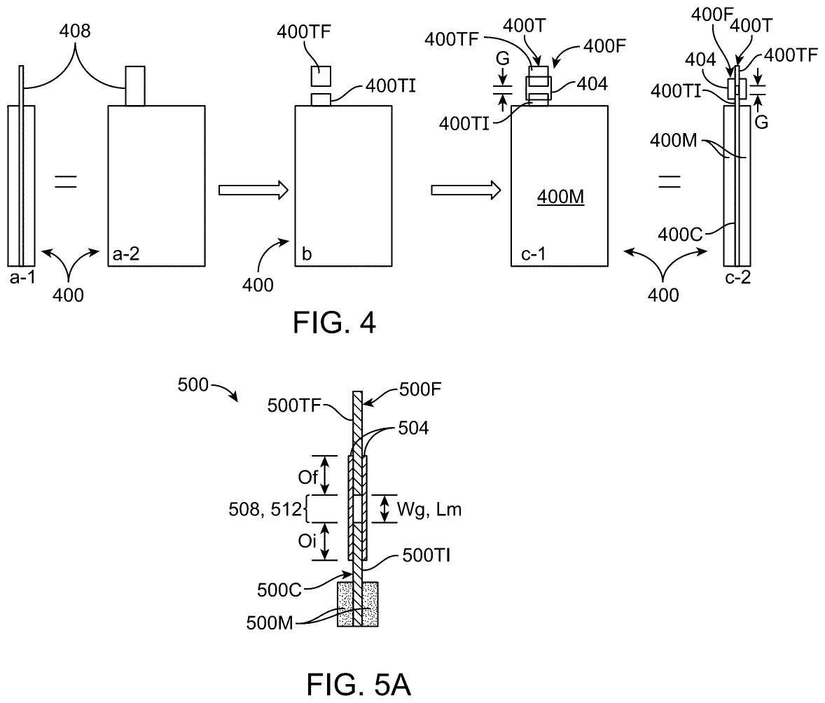

Another example of a built-in tab fuse is to use an electrically conductive tape, which functions as a built-in tab fuse. Generally, the electrically conductive tape functions as a current regulator, which is electrically conductive but with a higher resistance than the material(s) of the relevant current-collected tab. Under high current, the electrically conductive tape will polarize the cell voltage and thus limit the current flow. As those skilled in the art will readily appreciate, any materials and components with those properties can be used to achieve the same results. Examples include semiconductor material, a resistor, and a conventional fuse. The conductivity of each of these materials/components can be adjusted based on the cell design to meet the limiting current requirement. An example involving an electrically conductive tape is shown in FIGS. 4(c-1) and 4(c-2), which show an electrode 400 that includes a current collector 400C and electrode-active material 400M. Examples involving a semiconductor is shown in FIG. 7.

Referring to FIG. 4 and as alluded to above, the electrode 400 can be either a cathode or an anode, and, correspondingly, the electrode-active material 400M can be either a cathode-active material or an anode-active material. Examples of cathode-active materials and anode-active materials suitable for the electrode-active material 400M are discussed above. The current collector 400C may be made of any suitable electrically conductive material, for example, a metal such as copper or aluminum, among others. The electrode 400 includes a fused tab 400T that is composed of an integral tab portion 400TI, freestanding tab component 400TF that is spaced from the integral tab portion by a gap G, and a built-in tab fuse 400T that is composed of conductive tape 404. In this example, the electrically conductive tape 404 has pre-determined electrical resistance, which can be tuned by its thickness, the size of the gap G between the two proximate ends of the integral tab portion 400TI and the freestanding tab component 400TF, or the utilization of tape with different conductivities, and any combination or subcombination of these.

In this example, the resistivity of the electrically conductive tape 404 is higher than the resistivity of the electrically conductive material (e.g., aluminum or copper) of the integral tab portion 400TI and the freestanding tab component 400TF. Under short-circuit conditions (either external or internal), the controlled resistance of the electrically conductive tape 404 will constrain the maximum current flow during the short circuit of the corresponding cell (not shown), leading to a lower rate of heat generation. Under the condition of high temperature, the electrically conductive tape 404 can melt to break the circuit and stop the flow of electrical current between the integral tab portion 400TI and the freestanding tab component 400TF. In addition, the electrical conductivity of the electrically conductive tape 404 is high enough to enable the power capability of the corresponding cell under the normal operation condition usages. An option that can go along with this example is the utilization of positive temperature coefficient (PTC) material as the electrically conductive tape 404, which will increase the resistivity significantly when the temperature of the fused tab 400T rises due to high current under short circuit conditions. By increasing the resistivity as a function of temperature, the magnitude of the current is limited, resulting in a lower rate of heat generation. It is noted that the electrically conductive tape 404 may be an adhesive tape having suitable electrically conductive adhesive or a non-adhesive tape that can be secured to each of the integral tab portion 400TI and the freestanding tab component 400TF in any suitable manner, such as welding, heat-sealing, or brazing.

As seen in FIG. 4 and as an example, a method of providing the fused tab with the built-in tab fuse 400T (FIGS. 4(c-1) and 4(c-2)) using the electrically conductive tape 404 may begin with the electrode 400 having a full tab 408, as seen in FIGS. 4(a-1) and 4(b-2). The electrode 400 may be any suitable electrode, including a conventional electrode, an electrode of an existing cell design, or an electrode of a new cell design. As illustrated in FIG. 4(b), the tab is separated into two parts, namely the integral tab portion 400TI that remains integral with the current collector 400C and the freestanding tab component 400TF, for example, by cutting it using any suitable cutting process. While the full tab 408 can be cut to make the built-in tab fuse 400T, an alternative approach, relative to the example of FIGS. 4(a-1), 4(a-2), and 4(b), would be to provide the electrode 400 with a shorter tab (in the vertical direction relative to FIG. 4) than shown (e.g., just the integral tab portion 400TI of FIG. 4(b)) and then provide a separate tab part (e.g., the freestanding tab component 400TF in each of FIGS. 4(a-1), 4(a-2), and 4(b)) that is of a size suitable for making the finished fused tab 400T, i.e. end up at the desired overall length, as seen in each of FIGS. 4(c-1) and 4(c-2).

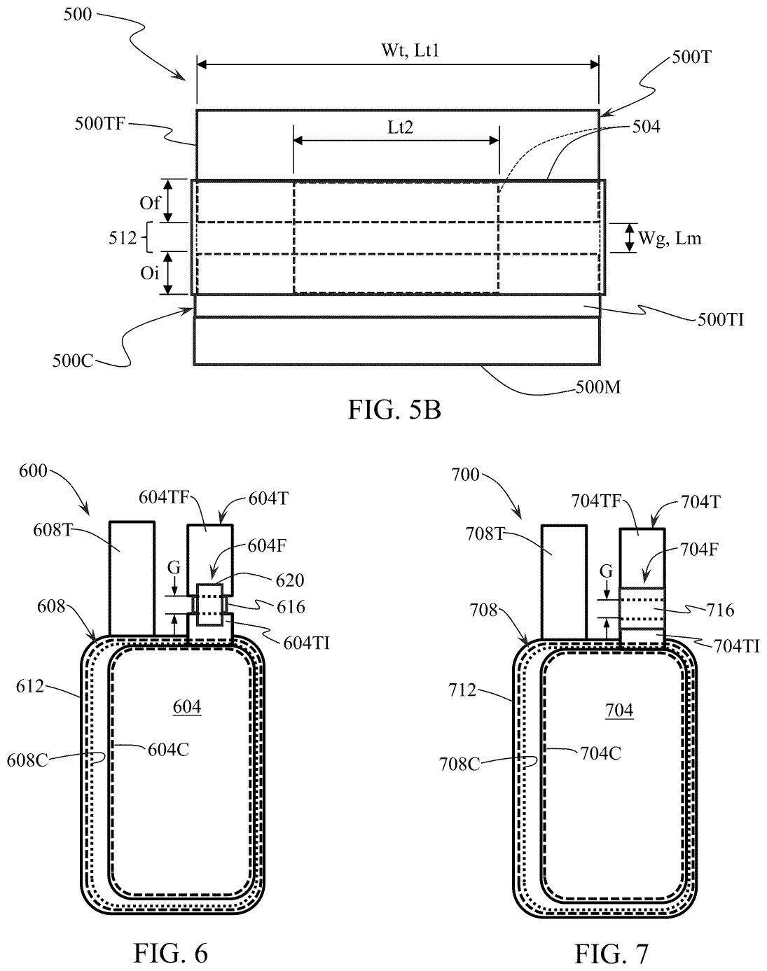

Once the full tab 408 has been cut to create the freestanding tab component 400TF or a separate part has been provided for the freestanding tab component, the freestanding tab component and the integral tab portion 400TI are located relative to one another so as to create a desired gap, G, between them, as seen in each of FIGS. 4(b), 4(c-1), and 4(c-2) of FIG. 4. As mentioned above, the size of this gap G between the integral tab portion 400TI and the freestanding tab component 400TF may be one of the variables for tuning the maximum electrical current that the built-in tab fuse 400F can sustain before the fuse melts and breaks the electrical circuit. Once the integral tab portion 400TI and the freestanding tab component 400TF are properly located relative to one another to form the desired gap G, one or more pieces of the electrically conductive tape 404 are engaged with and secured to both of the integral tab portion and the freestanding tab component so as to span the gap. FIGS. 5A and 5B illustrate an example of how the electrically conductive tape 404 with the integral tab portion 400TI and the freestanding tab component 400TF can be configured in more detail.

Referring now to FIGS. 5A and 5B, these figures show some details of an example electrode 500 having a built-in tab fuse 500F of the electrically-conductive-tape type illustrated in FIGS. 4(c-1) and 4(c-2). In this example, the electrode 500 includes a current collector 500C, an electrode-active material 500M applied to each face of the current collector, and a fused tab 500T having a built-in tab fuse 500F composed of electrically conductive tape 504. The tab fuse 500F includes a freestanding tab component 500TF and an integral tab portion 500TI that are spaced apart by a gap 508 having a width, Wg, and that also defines a length, Lm, of a melt region 512 of the electrically conductive tape 504 that melts when subjected to an electrical current higher than the maximum electrical current that the melt region is designed to sustain without melting. As those skilled in the art will readily appreciate, both the total cross-sectional area and the length Lm of the electrically conductive tape 504 in the melt region 512 will, along with the relevant electrical properties of the electrically conductive tape, determine the maximum amount of electrical current that the electrically conductive tape can sustain in the melt region without melting, thus defining the amount of electrical current at which the built-in tab fuse 500F will break the electrical circuit.

As discussed above, the width Wg of the gap 508, and hence the length Lm of the melt region 512 of the electrically conductive tape 504, is one of several variables that contribute to the tuning of the resistance of the electrically conductive tape that causes the electrically conductive tape to melt and thereby break the electrical circuit to prevent further electrical-resistance-based overheating. As those skilled in the art will readily appreciate, the gap width Wg and melt-region length Lm may be any value suitable for a particular design and will depend on a wide variety of factors, including, but not limited to any one or more of the electrical resistivities of the electrically conductive tape 504 and the material of the fused tab 500T, the transverse cross-sectional area of the freestanding tab component 500TF and an integral tab portion 500TI, the number of layers of the electrically conductive tape 504, the design maximum current flow permitted through the melt region 512, and the thermal-resistivity profile if a PTC material is used, among others. Given a set of design parameters, those skilled in the art will be able to determine the appropriate value of the gap width Wg and the melt-region length Lm without undue experimentation. Of course, some testing may be needed, but no more than routine testing common in the art.

As also shown in FIGS. 5A and 5B, the electrically conductive tape 504 overlaps with the freestanding tab component 500TF and the integral tab portion 500TI by, respectively, distances Of and Oi, which may be the same as or different from one another. The value(s) of these overlap distances Of and Oi may be any value(s) suitable for the particular application. Generally, the overlap distances Of and Oi need to be large enough so as to carry the amount of electrical current needed to ensure that any melting that occurs in the electrically conductive tape 504 occurs in the melt region 512. As those skilled in the art will readily appreciate, the overlap distances Of and Oi can be determined based on a number of parameters, including the conductivity of the electrically conductive tape 504, the resistivity of the interface between the electrically conductive tape and each of the freestanding tab component 500TF and an integral tab portion 500TI, and the amount of electrical current that must be carried between the electrically conductive tape and each of the freestanding tab components and the integral tab portion, among others.

As particularly seen in FIG. 5B, the length, Lt, of the electrically conductive tape 504 along the direction of the tab width, Wt, can vary to suit a particular design. FIG. 5B shows two examples, one in which the electrically conductive tape 504 (solid lines) is wrapped all the way around the fused tab 500T once such that the tape length Lt1 along one face of the fused tab is largely equal to the tab width Wt, and one in which the electrically conductive tape has a length Lt2 shorter than the tab width Wt. Many other possibilities exist. Depending on the characteristics of the electrically conductive tape 504, one or two or more layers of it may be needed. When the length Lt1 of the electrically conductive tape 504 is equal to the tab width Wt and two or more layers are needed, those layers may be provided by wrapping the electrically conductive tape around the fused tab 500T more than once until the desired number of layers is present on each face of the fused tab. When the length Lt2 of the electrically conductive tape 504 is less than the tab width Wt and two or more layers are needed, those layers may be provided by simply securing one or more layers on top of the layer that is adhered directly to the freestanding tab component 500TF and an integral tab portion 500TI.

Although not shown in FIGS. 5A and 5B, it is noted that in some embodiments the electrically conductive tape 504 may be covered with a thermally insulating dielectric tape to contain and control the heating of the melt region 512 of the electrically conductive tape. In some embodiments, the thermally insulating dielectric tape may extend onto one or both of the portions of freestanding tab component 500TF and an integral tab portion 500TI not covered by the electrically conductive tape 504. See, for example, FIGS. 3(d-1) and 3(d-2) for an example of application of such thermally insulating dielectric tape 316.

Those skilled in the art will readily appreciate that embodiments made in accordance with principles illustrated in FIGS. 5A and 5B will need to be designed according to the design parameters of the particular cell at issue, such as, but not limited to, design output current, maximum charging current, the tab width Wt, and the tab thickness, among others. Using these and/or other parameters, those skilled in the art will be able to determine parameters relating to the electrically conductive tape 504, including, but not limited to, the type of tape (e.g., based on its electrical properties), the gap width Wg/melt-region length Lm, the overlap distances Of and Oi, and the number of tape layers, among others. Because of the wide variety of cell and tape design parameters, those skilled in the art would need to engage in ordinary engineering testing, and not undue experimentation, to devise one or more suitable designs for the fused tab 500T at issue.

FIG. 6 shows an example subassembly 600 of a cell (not shown) in which the subassembly is composed of a cathode 604 and an anode 608 having a dielectric separator 612 therebetween. The cathode 604, anode 608, and separator 612 may be of any suitable type, such as any of the types described above, among others. In addition, the cell (not shown) can be any suitable cell, such as any of the cells described above. In this example, the anode 608 has a conventional rectangular tab 608T integrally formed with a current collector 608C, and the cathode 604 includes a fused tab 604T that includes an integral tab portion 604TI integrally formed with a current collector 604C, a freestanding tab component 604TF spaced from the integral tab portion by a gap, G, and a built-in tab fuse 604F that spans the gap. In this example, the tab fuse 604F comprises a substrate 616 that extends between the integral tab portion 604TI and the freestanding tab component 604TF and at least one conductive layer 620 applied to the substrate 616 and each of the integral tab portion and the freestanding tab component. For example, a second metal layer (not shown) may be applied to the face of the built-in tab fuse 604F facing away from the viewer of FIG. 6. The conductive layer 620 may be made of any suitable material, such as tin, silver, or a metallic paint, among others. In this example, the substrate 616 provides both physical strength to the built-in tab fuse 604F and a surface to which the conductive layer 620 can be applied. The substrate 616 may be made of any suitable dielectric material, such as a dielectric polymer or the like. It is noted that in other embodiments, the fused tab 604T can be moved to the anode 608 or similar fused tabs can be used on both the cathode 604 and the anode.

FIG. 7 shows another example subassembly 700 of a cell (not shown) in which the subassembly is composed of a cathode 704 and an anode 708 having a dielectric separator 712 therebetween. The cathode 704, anode 708, and separator 712 may be of any suitable type, such as any of the types described above, among others. In addition, the cell (not shown) can be any suitable cell, such as any of the cells described above. In this example, the anode 708 has a conventional rectangular tab 708T integrally formed with a current collector 708C, and the cathode 704 includes a fused tab 704T that includes an integral tab portion 704TI integrally formed with a current collector 704C, a freestanding tab component 704TF spaced from the integral tab portion by a gap, G, and a built-in tab fuse 704F that spans the gap. In this example, the tab fuse 704F comprises at least one semiconducting component 716 that extends between the integral tab portion 704TI and the freestanding tab component 704TF. For example, a second semiconducting component (not shown) may be applied to the face of the built-in tab fuse 704F facing away from the viewer of FIG. 7. The semiconducting component 716 may be made of any suitable semiconductor. In some embodiments, the semiconducting component 716 may be a freestanding component, such as a sheet. In some embodiments, the semiconducting component 716 may include a substrate (not shown, but that may be the same as or similar to the substrate 616 of FIG. 6) having a semiconductor applied thereto, such as using any known manner of applying semiconductor materials to substrates. In this example, the semiconductor component 716 provides both physical strength to the built-in tab fuse 704F and the conductive material that functions as a fuse. It is noted that in other embodiments, the fused tab 704T can be moved to the anode 708 or similar fused tabs can be used on both the cathode 704 and the anode.

In some aspects, the present disclosure is directed to a secondary-battery cell, which includes a container; an internal core, located within the container, that includes a plurality of current collectors and plurality of fused tabs corresponding, respectively, to the plurality of current collectors, wherein each fused tab includes: an integral tab portion that is directly connected to a corresponding one of the current collectors and is composed of a first electrically conductive material; a freestanding tab component spaced from the integral tab portion so as to define a gap between the freestanding tab component and the integral tab portion, the freestanding tab component composed of a second electrically conductive material; and a built-in tab fuse that comprises a third electrically conductive material that is different from each of the first and second electrically conductive materials and that spans the gap so as to electrically connect the integral tab portion and the freestanding tab component with one another and to define a melt region between the integral tab portion and the freestanding tab component.

In one or more embodiments of the secondary-battery cell, the electrically conductive tape comprises a positive temperature coefficient material.

In one or more embodiments of the secondary-battery cell, the electrically conductive tape is selected from the group consisting of an adhesive tape, a heat-bond tape, and a weld-bond tape.

In one or more embodiments of the secondary-battery cell, the electrically conductive tape of the built-in tab fuse is provided in at least two layers.

In one or more embodiments of the secondary-battery cell, the electrically conductive tape of the built-in tab fuse is wrapped around the fused tab at least once.

In one or more embodiments of the secondary-battery cell, the electrically conductive tape of each built-in tab fuse is wrapped around the current-collector more than once.

In one or more embodiments of the secondary-battery cell, also including a dielectric layer applied over the electrically conductive tape.

In one or more embodiments of the secondary-battery cell, the dielectric layer is a thermally insulating layer.

In some aspects, the present disclosure is directed to a method of manufacturing a secondary-battery cell having an internal core, contained in a container, that includes a plurality of current collectors each having a tab located within the container. The method includes, for each of the fused tabs, providing an integral tab portion that is integral to a corresponding one of the current collectors; providing a freestanding tab component so that it is spaced from the integral tab portion by a gap; and forming a built-in tab fuse that extends across the gap and electrically connects together the integral tab portion and the freestanding tab component.

In one or more embodiments of the method, forming the built-in tab fuse includes securing an electrically conductive tape to each of the integral tab portion and the freestanding tab component.

In one or more embodiments of the method, the electrically conductive tape comprises a positive temperature coefficient material.

In one or more embodiments of the method, the electrically conductive tape of each built-in tab fuse is provided in at least two layers.

In one or more embodiments of the method, the electrically conductive tape of each built-in tab fuse is wrapped around the fused tab at least once.

In one or more embodiments of the method, the electrically conductive tape of each built-in tab fuse is wrapped around the current-collector more than once.

In one or more embodiments of the method, also including selecting the gap as a function of a maximum electrical current that the fused tab is designed to accommodate.

In one or more embodiments of the method, each fused tab has a width, and the built-in tab fuse has a length in the direction of the width of the fused tab that is less than the width.

In one or more embodiments of the method, each fused tab has a width, and the built-in tab fuse has at least one portion that has a length in the direction of the width of the fused tab that is coextensive with the width.

In one or more embodiments of the method, also including applying a dielectric layer over the electrically conductive tape.

In some aspects, the present disclosure is directed to a method of designing an internal fused tab for a secondary battery, wherein the fused tab includes a built-in tab fuse and the internal fused tab has an integral tab portion and a freestanding tab component. The method includes determining a maximum design electrical current; determining electrical characteristics of an electrically conductive tape; and based on the maximum design electrical current: selecting a gap width between the integral and freestanding tab components so as to define a melt region for the electrically conductive tape; and selecting an amount of the electrically conductive tape to provide in the melt region so that, when the electrically conductive tape is provided to span the gap width, the electrically conductive tape melts when an electrical current flowing in the fused tab exceeds the maximum design electrical current.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A secondary-battery cell, comprising:
a container;
an internal core, located within the container, that includes a plurality of current collectors and plurality of fused tabs corresponding, respectively, to the plurality of current collectors, wherein each fused tab includes:
an integral tab portion that is directly connected to a corresponding one of the current collectors and is composed of a first electrically conductive material;
a freestanding tab component spaced from the integral tab portion so as to define a gap between the freestanding tab component and the integral tab portion, the freestanding tab component composed of a second electrically conductive material; and
a built-in tab fuse that comprises a third electrically conductive material that is different from each of the first and second electrically conductive materials and that spans the gap so as to electrically connect the integral tab portion and the freestanding tab component with one another and to define a melt region between the integral tab portion and the freestanding tab component.

2. The secondary-battery cell of claim 1, wherein the built-in tab fuse includes a dielectric component physically connecting the integral tab portion and the freestanding tab component with one another, wherein the third electrically conductive material is applied at least to the dielectric component.

3. The secondary-battery cell of claim 2, wherein the dielectric component comprises a dielectric tape.

4. The secondary-battery cell of claim 2, wherein the third electrically conductive material comprise tin.

5. The secondary-battery cell of claim 2, wherein the third electrically conductive material comprises silver.

6. The secondary-battery cell of claim 1, wherein each of the first, second, and third electrically conductive materials has an electrical conductivity, and the electrical conductivity of the third electrically conductive material is less than the electrical conductivity of each of the first and second electrically conductive materials.

7. The secondary-battery cell of claim 6, wherein each of the first and second electrically conductive materials is a metal, and the third electrically conductive material is a semiconductor.

8. The secondary-battery cell of claim 1, wherein the built-in tab fuse comprises an electrically conductive tape that physically connects the integral tab portion and the freestanding tab component with one another.

9. The secondary-battery cell of claim 1, wherein each of the fused tabs is a cathode tab.

10. The secondary-battery cell of claim 1, wherein each of the fused tabs is an anode tab.

11. The secondary-battery cell of claim 1, wherein the first electrically conductive material is a first metal, the second electrically conductive material is a second metal, and the third electrically conductive material is a third metal that is different from each of the first and second metals.

12. The secondary-battery cell of claim 11, wherein the third electrically conductive material comprises tin.

13. The secondary-battery cell of claim 12, wherein each of the first and second electrically conductive materials comprises copper.

14. The secondary-battery cell of claim 12, wherein each of the first and second electrically conductive materials comprises aluminum.

15. The secondary-battery cell of claim 11, wherein the third electrically conductive material comprises silver.

16. The secondary-battery cell of claim 15, wherein each of the first and second electrically conductive materials comprises copper.

17. The secondary-battery cell of claim 15, wherein each of the first and second electrically conductive materials comprises aluminum.

18. A secondary-battery cell, comprising:
a container;
an internal core, located within the container, that includes a plurality of current collectors and plurality of fused tabs corresponding, respectively, to the plurality of current collectors, wherein each fused tab is designed and configured to not melt under operating electrical currents and includes:
a built-in tab fuse designed and configured to melt at a predetermined excursion electrical current greater than each of the operating electrical currents; and
a dielectric tape applied to the built-in tab fuse.

19. The secondary-battery cell of claim 18, wherein each fused tab has a transverse cross-sectional area, and each corresponding built-in tab fuse is formed by reducing the transverse cross-sectional area in a region of the fused tab.

20. The secondary-battery cell of claim 18, wherein the dielectric tape is wrapped around the built-in tab fuse at least once.
